(19) United States
(12) Patent Application Publication
(10) Pub. No.: US 2005/0174162 A1
(43) Pub. Date: Aug. 11, 2005

(54) Configurable voltage generator

(75) Inventors: Tung-Shuan Cheng, Yongkang City (TW); Hung-Jen Liao, Hsin-Chu (TW); Wei Hwang, La Verne, CA (US)

Correspondence Address: DUANE MORRIS, LLP;IP DEPARTMENT, ONE LIBERTY PLACE, PHILADELPHIA, PA, 19103-7396, US

(73) Assignee: Taiwan Semiconductor Manufacturing Company

(21) Appl. No.: 10/775,731

(22) Filed: Feb. 9, 2004

(51) Int. Cl. H02J 1/00

(52) U.S. Cl. 327/535

(57) ABSTRACT

A configurable voltage generator is disclosed for generating multiple levels of output. It includes an oscillator module for generating a pumping signal, a digital to analog (D/A) converter coupled to the oscillator for generating one or more analog signals of a predetermined voltage level based on the pumping signal as configured by a set of inputs thereof, and a charge pump coupled to the D/A converter for producing a direct current (DC) output based on the analog signals generated by the D/A converter.

### BACKGROUND

The present disclosure relates generally to semiconductor designs, and more particularly to the design of integrated circuits (ICs). Still more particularly, the present disclosure relates to a system and method to generate and apply bias voltage to the substrate of IC transistors, thereby raising the threshold voltage and suppressing leakage current.

Leakage current is the amount of current that is leaked to a grounding conductor, through an unintended insulation material, due to poorly designed integrated circuit (IC) structures or improper grounding. In properly designed IC structures, leakage current can generally be ignored because it is limited to safe levels. However, excess leakage current may appear when an IC component is defective, poorly designed, or has foreign particles that prohibit the normal functioning thereof. Also, leakage current generally increases as active-state temperature increases. One undesirable effect of excess leakage current is the loss of power, which is particularly significant in mobile applications (such as portable computer or personal digital assistants) where power supply is scarce and power conservation is of paramount importance.

Leakage current is especially known to pose problems at high temperatures. Typically, leakage current is manageable and within a safe level when an IC application is in an idle state, when the operating temperature is not very high. However, when the IC application is in an active state, operating temperature may reach a very high level. At this high temperature, leakage current may become very significant. As an example, leakage may easily increase by up to hundreds of times as temperature is raised between 50 to 80 degrees from room temperature.

One method to limit leakage current is by applying a reverse bias voltage to the substrate of Metal-Oxide Semiconductor (MOS) transistors, thereby raising the threshold voltage of the MOS transistors and preventing current from easily punching through the substrate. Many designs of reverse bias voltage generators already exist in semiconductor applications. However, these designs, while generally compact in size, are implemented in such a way that they can only generate a specific, pre-defined level of reverse bias voltage. These pre-defined reverse bias voltages may not be optimized for a particular application (such as power reduction), and lack the flexibility in supplying reverse bias voltages for different nodes with different configurations. The lack of flexibility in generating a variable range of reverse bias voltages contributes to inadequate control of leakage current.

Desirable in the art of IC designs are improved reverse bias voltage generation techniques that allow a configurable voltage generator that generates a range of reverse bias voltage levels, thereby widening its applications and improving the control of leakage current.

### SUMMARY

In view of the foregoing, a system is provided to allow different input settings that generate a range of voltages.

In one example, a configurable voltage generator is disclosed for generating multiple levels of output. It includes an oscillator module for generating a pumping signal, a digital to analog (D/A) converter coupled to the oscillator for generating one or more analog signals of a predetermined voltage level based on the pumping signal as configured by a set of inputs thereof, and a charge pump coupled to the D/A converter for producing a direct current (DC) output based on the analog signals generated by the D/A converter. The generated voltage can then be applied on the substrate of MOS transistors, thereby suppressing leakage current.

Various aspects and advantages will become apparent from the following detailed description, taken in conjunction with the accompanying drawings, illustrating the principles of the disclosure by way of examples.

### BRIEF DESCRIPTION OF THE DRAWINGS

FIG. 1 presents a relationship between a leakage current ratio and reverse bias in MOS transistors.

FIG. 2 presents relationships between actual leakage current and reverse substrate-bias at various temperatures in P-channel MOS transistors.

FIG. 3A illustrates a substrate-bias generator in accordance with a first example of the present disclosure.

FIGS. 3B-3D present voltage levels at different nodes in accordance with the first example of the present disclosure.

FIG. 4A illustrates a typical n-bit D/A converter.

FIG. 4B presents a transfer characteristic diagram of the typical n-bit D/A converter.

FIG. 4C presents a signal diagram for the output of the typical n-bit D/A converter.

FIG. 5A presents a typical charge pump.

FIG. 5B presents a transfer characteristic diagram of the typical charge pump.

FIG. 5C presents a signal diagram for the output of the typical charge pump.

FIG. 6 presents a voltage diagram in accordance with the first example of the present disclosure.

FIG. 7A illustrates a substrate-bias generator in accordance with a second example of the present disclosure.

FIGS. 7B-7D present voltage levels at different nodes in accordance with the second example of the present disclosure.

### DESCRIPTION

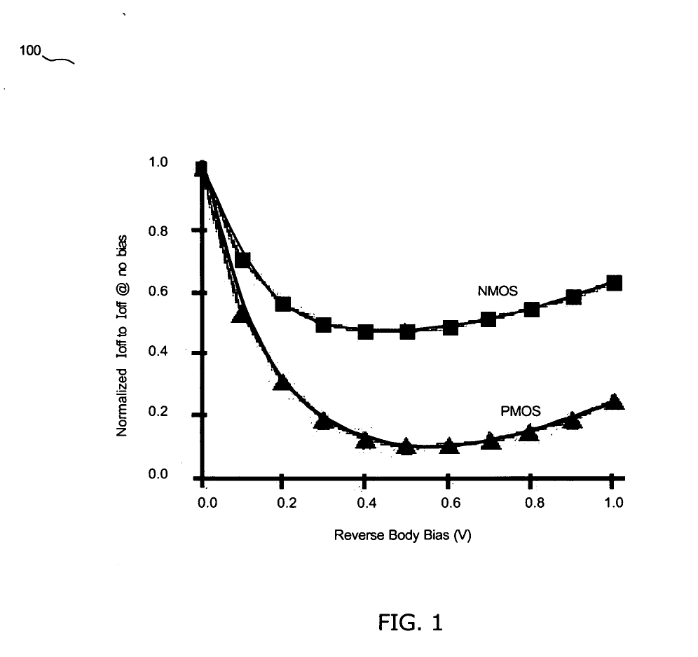

FIG. 1 presents a diagram 100 whose Y-axis represents the normalized leakage current (Ioff) to the leakage current (Ioff) at no bias, and whose X-axis represents the reverse substrate-bias voltage for N-channel MOS (nMOS) and P-channel MOS (pMOS) transistors. As shown, the highest leakage current occurs at zero substrate-bias. As the diagram 100 illustrates, for both nMOS and pMOS transistors, there is a minimum leakage at some given reverse substrate-bias at a given temperature. It is noted that a predefined reverse substrate-bias may not achieve the minimum level of normalized leakage current. Further, for different technology generations, the optimal reverse substrate-bias voltage varies. Therefore, a fixed reverse substrate-bias voltage does not suit devices of different technology generations well.

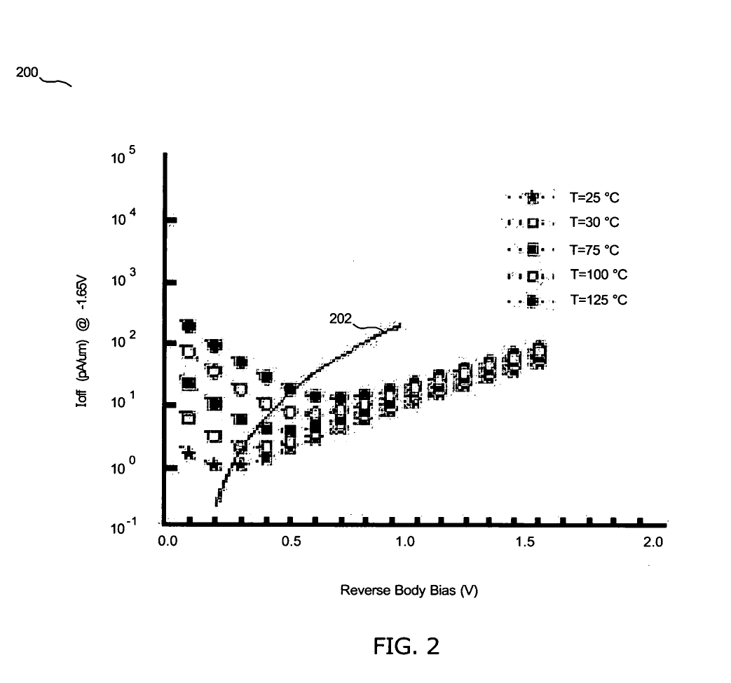

FIG. 2 presents a diagram 200 whose Y-axis represents the actual leakage current when the drain bias is at −1.65 volts, and whose X-axis represents the reverse substrate-bias for pMOS transistors. In this example, a pMOS transistor is used. The top-most curve indicates the relationship between leakage current and reverse substrate-bias for the transistor at an operating temperature of 125° C., while the bottom-most curve indicates the relationship between leakage current and reverse substrate-bias for the transistor at an operating temperature of 25° C. A curve 202 represents the locus of leakage minima across various operating temperatures. The significance of the curve 202 is that the leakage minimum varies significantly with temperature.

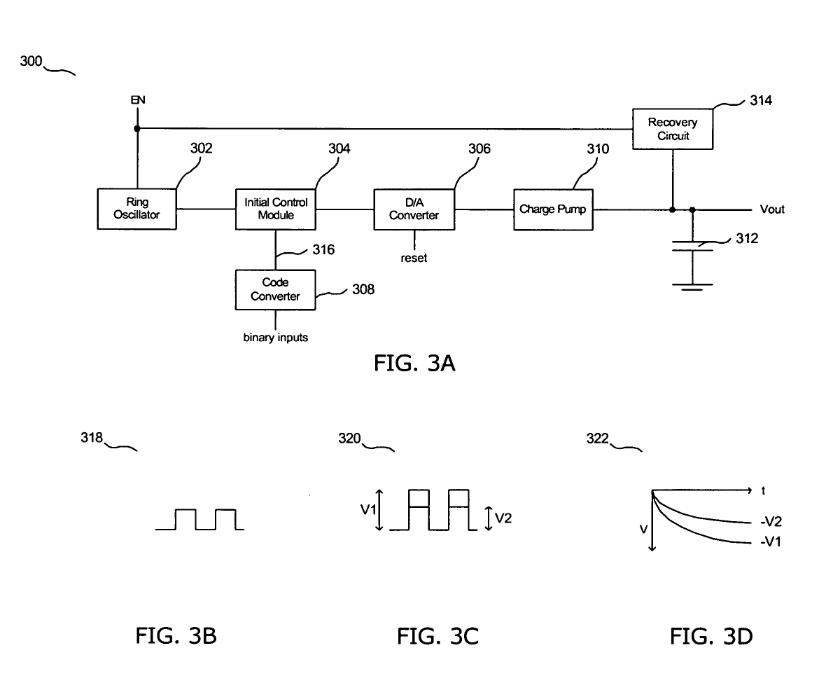

FIG. 3A illustrates a substrate-bias generator 300 in accordance with the first example of the present disclosure. The substrate-bias generator 300 includes a ring oscillator 302, an initial control module 304, a digital-to-analog (D/A) converter 306, a code converter 308, a charge pump 310, a load capacitor 312 and a recovery circuit 314. To initialize the substrate-bias generator 300, an enable signal EN, which may be a single positive pulse; is generated and fed to the ring oscillator 302.

The ring oscillator 302 then produces a square wave signal, thereby internally supplying pumping signals for the rest of the generator. The swing of the square wave signal is within the allowable operating voltage range. The initial control module 304 initializes D/A converter 306 and also serves to improve precision. The code converter 308 transforms a set of binary inputs to a set of thermometer signals 316, a set of finely-divided signals which is then received by the initial control module 304. In response to the code converter 308 and the initial control module 304, the D/A converter 306 generates a pumping, analog equivalent of the square wave. It is understood that the initial control module 304 and the code converter 308 may be deemed as a part of the D/A converter 306 and they may be optional for the design too. This pumping signal may be reset by applying a reset signal to the D/A converter 306. The charge pump 310 then converts the pumping signal to a direct-current (DC) voltage. This DC voltage level is smoothed into a signal Vout by a load capacitor 312. Therefore, Vout is essentially a finely-divided range of reverse bias voltage applicable to the substrate of the transistor. The more finely-divided this reverse bias voltage is, the more voltage option there is available that is optimally close to the specific voltage necessary to produce the minimum leakage current Ioff.

Typically, a 2-bit D/A converter is sufficient for reshaping the pumping signal. However, the precision of Vout may be further increased and improved with D/A converters with higher resolutions. For example, a 4-bit D/A converter may provide 16 finite steps between a zero voltage and the reference voltage. Finally, an optional recovery circuit 314 sends a short VSS pulse to Vout when the enable signal EN is positive, thereby resetting Vout and ensuring that voltage levels from previous operations are not carried over to the current operation of the generator.

FIGS. 3B to 3D present signal timing diagrams 318, 320 and 322, respectively, for various nodes of the substrate-bias generator as illustrated in FIG. 3A. The signal diagram 318 illustrates the square wave clock signal that is the output of the ring oscillator 302 after it has been initialized by the enable signal EN. The signal diagram 320 illustrates the pumping analog output of the D/A converter 306 after the D/A converter 306 receives signals from the initial control module 304. Voltages V1 and V2 are examples of the various analog voltage levels that may be generated by the D/A converter 306 and sent to the charge pump 310. The signal diagram 322 illustrates the DC voltage output of the charge pump after the charge pump processes the pumping analog signals from the D/A converter 306.

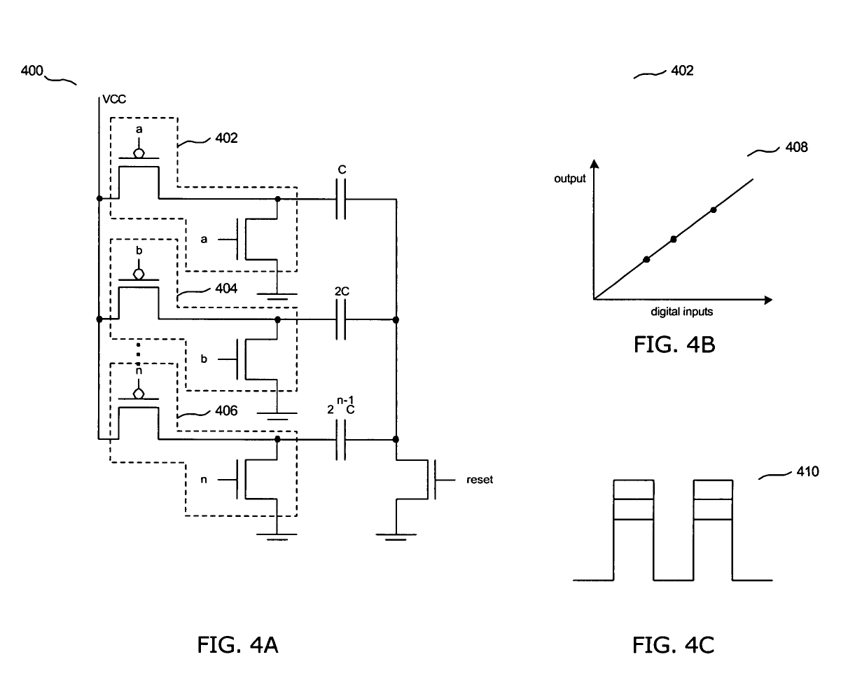

FIG. 4A illustrates a typical n-bit D/A converter 400 which transforms binary inputs into an analog equivalent in accordance with one example of the present disclosure. The D/A converter 400 has n inverters, each of whose inputs is tied to a binary bit, and whose outputs are tied to a capacitor of varying capacitance. For example, an inverter 402 whose input is tied to the binary bit “a” has its output tied to a capacitor with a capacitance C. Similarly, an inverter 404 whose input is tied to the binary bit “b” has its output tied to a capacitor with a capacitance 2C. Generally, an inverter 406 whose input is tied to the binary bit “n” has its output tied to a capacitor with a capacitance 2ⁿ⁻¹C. In other words, as the number “n” increases, the value of the bit becomes higher. The D/A converter 400 is reset by the reset signal by allowing the capacitors to discharge therethrough.

FIG. 4B presents a transfer characteristic diagram 408 that illustrates the linear relationship between digital inputs into the D/A converter 400 and the analog output of the said converter. The three points represent the various levels of digital inputs. FIG. 4C presents a signal diagram 410 that illustrates the output of the D/A converter 400. The three levels (or top lines) of outputs correspond to the three points of digital inputs as shown in FIG. 4B.

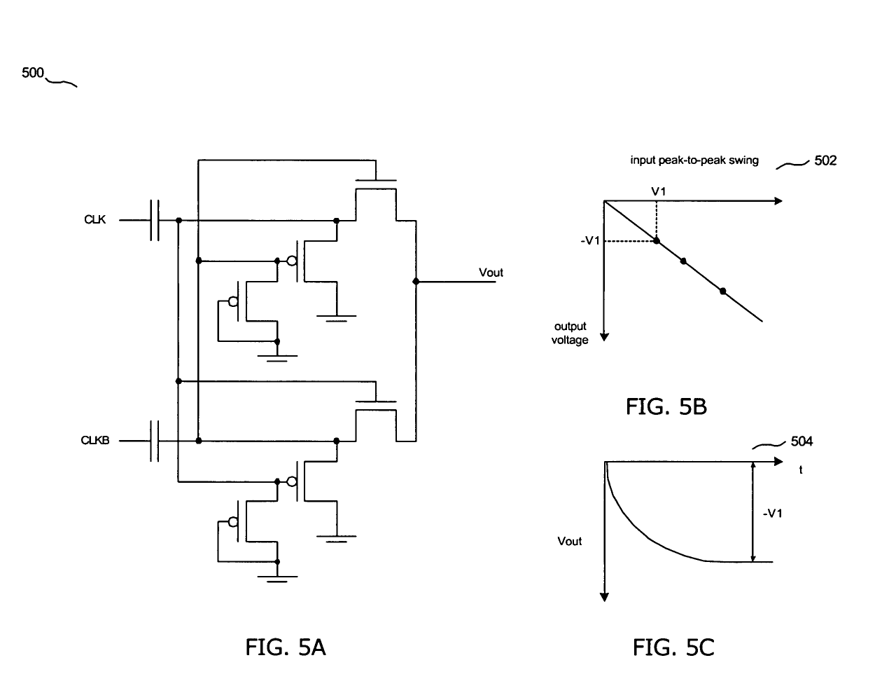

FIG. 5A presents a typical charge pump 500 which receives two pumping signals from the D/A converter 400. These two pumping signals are oppositely biased square waves CLK and CLKB. In FIG. 5B, a linear relationship 502 between the peak of the square wave CLK and the output Vout of the charge pump 500 is presented.

FIG. 5C presents a timing diagram 504 illustrating the DC output of the charge pump 500 with respect to time. This DC output is smoothed into the signal Vout by a load capacitor coupled to the charge pump 500. At steady state, the output is −V1, which is identical in magnitude to the pumping signal generated by the D/A converter 400 and received by the charge pump 500.

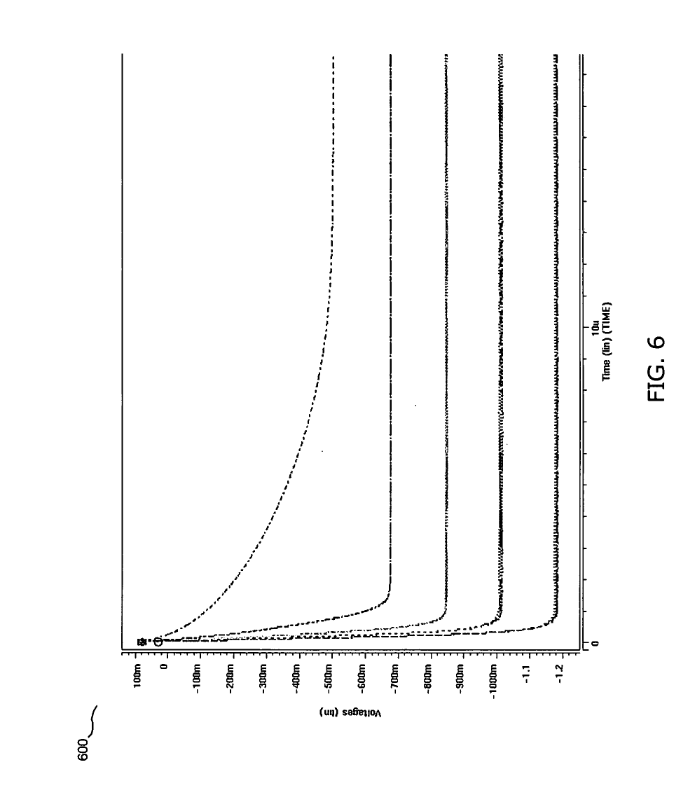

FIG. 6 presents a more detailed timing diagram 600 illustrating the various relationships between the intended negative bias voltage and the time required to allow this intended voltage to become usable. The various relationships correspond to various combinations of binary inputs. For example, the bottom-most relationship represents the highest combination of binary inputs, whereas the top-most relationship represents the lowest combination of binary inputs. A low combination of binary inputs would give a lower level of intended negative bias voltage change, and would need a longer period of time, due to a small pumping current, before that intended voltage change reaches steady state. By contrast, a high combination of binary inputs would give a higher level of intended negative bias voltage change, and would need a comparatively shorter period of time, due to a higher pumping current, before that intended voltage change reaches steady state. The difference in duration between using a small pumping current and a comparatively higher pumping current may be as much as 100 times.

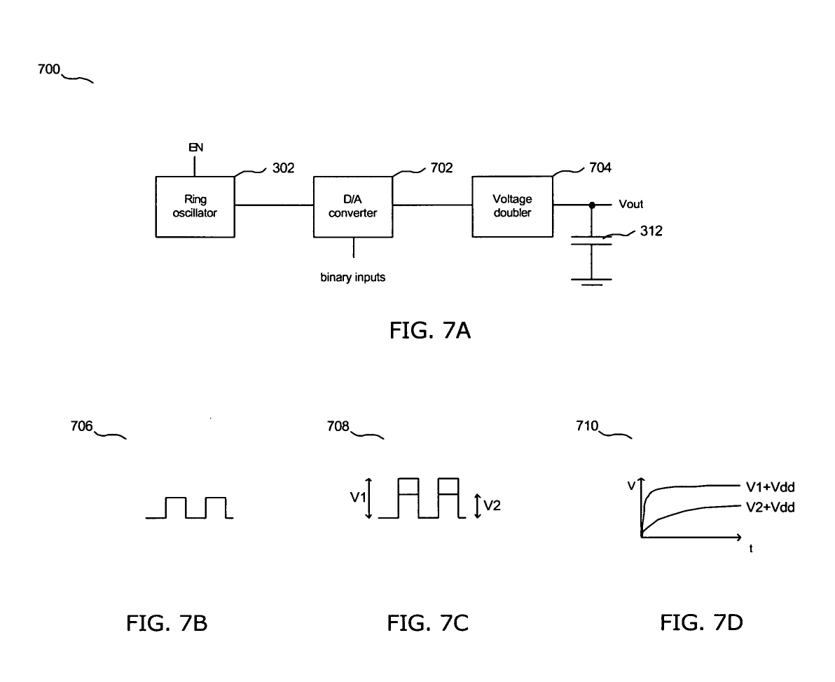

FIG. 7A illustrates a substrate-bias generator 700 in accordance with the second example of the present disclosure. The substrate-bias generator 700 includes the ring oscillator 302, a D/A converter 702, a voltage doubler 704 and the load capacitor 312. To initialize the substrate-bias generator 700, an enable signal EN, which may be a single positive pulse, is generated, and then received by the ring oscillator 302. The ring oscillator 302 then produces a square wave clock signal, thereby internally supplying pumping signals for the rest of the generator. The D/A converter 702 translates binary inputs into a pumping equivalent of the square wave. The voltage doubler 704 then converts the pumping signal to a DC voltage level similar to the function of the charge pump 310 in the substrate-bias generator 300. However, the voltage doubler 704 provides an additional functionality by scaling the pumping signal. In this example, the DC voltage level generated by the voltage doubler 704 is increased by 100 percent. The DC voltage level is then smoothed into a signal Vout by a load capacitor 312.

FIGS. 7B to 7D present signal timing diagrams 706, 708 and 710, respectively, for various nodes of the substrate-bias generator as illustrated in FIG. 7A. The signal diagram 706 illustrates the square wave clock signal that is the output of the ring oscillator 302 after it has been initialized by the enable signal EN. The signal diagram 708 illustrates the analog output of the D/A converter 702 after the D/A converter 702 receives signals from the initial control module 304. Voltages V1 and V2 are examples of the various analog voltage levels that may be generated by the D/A converter 702 and sent to the voltage doubler 704. The signal diagram 710 illustrates the DC voltage output of the voltage doubler after the voltage doubler receives analog signals from the D/A converter 702. The voltage doubler 704 generates its voltage output as a sum of the supply voltage and swing of the output of the D/A converter 702. For example, if the analog signal from the D/A converter 702 is V1, Vout at steady state will be V1+Vdd. If the analog signal from the D/A converter 702 is V2, Vout at steady state will be V2+Vdd. As such, the voltage doubler not only serves as a charge pump, but also as a scaling apparatus for the substrate-bias generator 700.

As it can be appreciated, the configurable substrate-bias generator as disclosed provide various voltage levels to be used for reducing the leakage current. Devices belong to different technology generations can use the same substrate-bias generator by adjusting input values. This thus provides a very flexible circuit module for semiconductor device manufacturing.

The above disclosure provides many different embodiments, or examples, for implementing different features of the disclosure. Specific examples of components, and processes are described to help clarify the disclosure. These are, of course, merely examples and are not intended to limit the disclosure from that described in the claims.

Although illustrative embodiments of the disclosure have been shown and described, other modifications, changes, and substitutions are intended in the foregoing disclosure. Accordingly, it is appropriate that the appended claims be construed broadly and in a manner consistent with the scope of the disclosure, as set forth in the following claims.

1. A configurable voltage generator comprising:
an oscillator module for generating a pumping signal;
a digital to analog (D/A) converter coupled to the oscillator for generating an analog signal of a predetermined voltage level based on the pumping signal as configured by a set of inputs thereof; and
a charge pump coupled to the D/A converter for producing a direct current (DC) output based on the analog signals generated by the D/A converter,
wherein said direct current output is configurable by adjusting the inputs of the D/A converter.

2. The generator of claim 1 further comprising a load capacitor coupled to the charge pump for smoothing the output.

3. The generator of claim 1 wherein the oscillator is a ring oscillator.

4. The generator of claim 3 wherein the pumping signal is a square wave signal.

5. The generator of claim 4 wherein a voltage swing of the square wave signal is within a predetermined operating voltage range.

6. The generator of claim 1 wherein the charge pump is a negative charge pump for generating at least one configurable negative output to be used as a substrate-bias voltage for reducing leakage of a semiconductor device.

7. The generator of claim 1 further comprising a recovery module for clearing the output before generating a new value.

8. The generator of claim 1 wherein the D/A converter further includes an initial control module for initializing the D/A converter.

9. The generator of claim 8 wherein the D/A converter further includes a code converter for transforming the inputs to a set of thermometer signals.

10. The generator of claim 1 wherein the D/A converter is selected with a predetermined number of inputs based on a predetermined number of steps needed for the analog signals generated.

11. The generator of claim 1 wherein the charge pump is a voltage doubler producing the output as a sum of a voltage output swing of the D/A converter and a supply voltage.

12. A configurable voltage generator for providing a substrate-bias voltages for reducing leakage current, the generator comprising:
an oscillator module for generating a square wave pumping signal;
a digital to analog (D/A) converter coupled to the oscillator for generating an analog signal of a predetermined voltage level based on the pumping signal as configured by a set of inputs thereof; and
a negative charge pump coupled to the D/A converter for producing a direct current (DC) output based on the analog signals generated by the D/A converter.

13. The generator of claim 12 further comprising a load capacitor coupled to the negative charge pump for smoothing the output.

14. The generator of claim 12 wherein a voltage swing of the square wave pumping signal is within a predetermined operating voltage range.

15. The generator of claim 12 further comprising a recovery module for clearing the output before generating a new value.

16. The generator of claim 12 wherein the D/A converter is selected with a predetermined number of inputs based on a predetermined number of steps needed for the analog signals generated.

17. A method for producing one or more voltages by a configurable voltage generator for providing one or more substrate-bias voltages for reducing leakage current, the method comprising:
activating an oscillator module for generating a square wave pumping signal;
selecting a set of inputs to a digital to analog (D/A) converter coupled to the oscillator for generating an analog signal of a predetermined voltage level based on the pumping signal; and
wherein a negative charge pump coupled to the D/A converter produces a direct current (DC) output based on the analog signals generated by the D/A converter as configured by the selected inputs.

18. The method of claim 17 further comprising smoothing the output by a load capacitor coupled to the negative charge pump.

19. The method of claim 17 further comprising clearing the output before generating a new value.

20. The method of claim 17 further comprising determining a desired substrate-bias voltage based on an optimal effect on the leakage current.
